(19) United States
(12) Patent Application Publication
(10) Pub. No.: US 2016/0260363 A1
(43) Pub. Date: Sep. 8, 2016

(54) ELECTROLUMINESCENT RESIDENTIAL ADDRESS PLAQUE

(71) Applicant: Plainview Industries, LLC, Charlotte, MI (US)

(72) Inventor: Christopher J. Hall, Charlotte, MI (US)

(21) Appl. No.: 15/053,523

(22) Filed: Feb. 25, 2016

Related U.S. Application Data
(60) Provisional application No. 62/128,244, filed on Mar. 4, 2015.

(51) Int. Cl. G09F 13/22; G09F 7/18

(52) U.S. Cl. CPC G09F 13/22; G09F 7/18; G09F 2007/1873

(57) ABSTRACT

An illuminating address plaque assembly or kit includes a plurality of character elements selected to be arranged and generally fixed in a desired address. An electroluminescent wire or component is disposed over the character elements in a shape or pattern that corresponds with the alphanumeric display of the respective character portion to illuminate the desired address. The plurality of character elements may have a frame portion supporting a character portion that displays the alphanumeric character, whereby the frame portions may interconnect to form a plaque unit with the character portions arranged in the desired address. The electroluminescent wire may be configured to operate in a select illumination mode, such as by selecting a desired illumination mode with a wireless device from a remote location.

### CROSS-REFERENCE TO RELATED APPLICATIONS

The present application claims benefit under 35 U.S.C. §119(e) of U.S. Provisional Application Ser. No. 62/128,244, entitled ELECTROLUMINESCENT RESIDENTIAL ADDRESS PLAQUE, filed Mar. 4, 2015, which is hereby incorporated herein by reference in its entirety.

### FIELD OF THE INVENTION

The present invention generally relates to an address display or plaque, and more particularly to an address plaque assembly or kit that has customizable characters, such as for displaying a residential address or house number.

### BACKGROUND OF THE INVENTION

It is generally known to add reflective media to an address display, such as directly to individual characters of an address or to a background surrounding the characters of the address. The reflective media inherently requires light to be directed at the address for the reflective media to have any lighting effect. Other attempts at increasing visibility of an address have included the use of light emitting diodes (LEDs) and incandescent light bulbs to simply provide a spotlight on the address or to backlight opaque address characters. These prior attempts offer little in terms of customization, effective illumination, address readability, cost effectiveness, weather resistance, and attractive visual appeal.

### SUMMARY OF THE PRESENT INVENTION

The present invention generally provides an illuminating address plaque assembly or kit that includes a plurality of character elements selected to be arranged and generally fixed in a desired address. An electroluminescent wire or component is disposed over the character elements in a shape or pattern that corresponds with the alphanumeric display of the respective character portion to illuminate the desired address. An intermediate section of the electroluminescent wire or component may be engaged with an attachment feature, such as a channel disposed on the character element, to support or secure the electroluminescent wire or component in the alphanumeric shape at the respective character element. The end sections of the electroluminescent wire may extend to a rear portion of the character element to operably couple with a power source for illuminating the electroluminescent wire or component. Optionally, the plurality of character elements may have a frame portion supporting a character portion that displays the alphanumeric character, whereby the frame portions may interconnect to form a plaque unit with the character portions arranged in the desired address. Also, the plurality of character elements may, optionally, attach to a base panel in a linear arrangement that displays the desired address. Further, the electroluminescent wire may optionally be configured to operate in a select one of a solid illumination mode and a flashing illumination mode, such as by selecting a desired illumination mode with a wireless device from a remote location.

In accordance with one aspect of the present invention, an illuminating address plaque assembly includes a plurality of character elements arranged to display a desired address. A front display portion of each of the plurality of character elements includes an attachment feature. An electroluminescent wire includes an intermediate section that is engaged with the attachment feature and is disposed at or near the front display portion in a pattern corresponding with an alphanumeric shape of the respective character element. End sections of the electroluminescent wire extend through the front display portion to a rear portion of the respective character element for operably coupling with a power source.

In accordance with another aspect of the present invention, an illuminating address plaque assembly includes a plurality of character elements that each have a frame portion supporting a character portion displaying an alphanumeric character. The frame portions of the plurality of character elements are interconnected to form a plaque unit with the character portions arranged in a desired address. An electroluminescent wire has an intermediate section coupled with the character portion of at least one of the plurality of character elements and disposed in a shape corresponding with the alphanumeric character of the respective character portion. The end sections of the electroluminescent wire extend to a rear portion of the plaque structure to operably couple with a power source that selectively illuminates the desired address.

In accordance with yet another aspect of the present invention, a method of assembling an illuminating address plaque includes selecting a plurality of character elements that each have an alphanumeric character. The selected plurality of character elements are then arranged in a fixed configuration to display a desired address with the corresponding alphanumeric characters. An electroluminescent wire is attached at a front display portion of the character elements in a pattern corresponding with at least a portion of the alphanumeric character of the respective character element. The electroluminescent wire is inserted through the front display portion of the character elements to extend to a rear portion of the respective character element.

These and other objects, advantages, purposes and features of the present invention will become apparent upon review of the following specification in conjunction with the drawings.

### BRIEF DESCRIPTION OF THE DRAWINGS

FIG. 1 is an environmental perspective view of two electroluminescent address plaques attached to a house and post, in accordance with the present invention;

FIG. 2 is a front upper perspective view of a horizontally arranged electroluminescent address plaque shown in FIG. 1;

FIG. 2A is a front upper perspective view of a vertically arranged electroluminescent address plaque shown in FIG. 1;

FIG. 2B is a front upper perspective view of a diagonally arranged electroluminescent address plaque;

FIG. 3 is a rear upper perspective view of the arranged electroluminescent address plaque shown in FIG. 2, showing a character module detached;

FIG. 4 is a front upper perspective view of a character module of the electroluminescent address plaque shown in FIG. 2;

FIG. 5 is a rear upper perspective view of the character module of the electroluminescent address plaque shown in FIG. 4;

FIG. 6 is a rear elevational view of the character module of the electroluminescent address plaque shown in FIG. 4;

FIG. 7 is a front elevational view of different character modules of an electroluminescent address plaque, showing whole number embodiments of the character modules;

FIG. 8 is a front upper perspective view of a horizontally arranged electroluminescent address plaque;

FIG. 8A is a front upper perspective view of a vertically arranged electroluminescent address plaque;

FIG. 8B is a front upper perspective view of a diagonally arranged electroluminescent address plaque;

FIG. 9 is an upper perspective view of a portion of the electroluminescent address plaque shown in FIG. 8, showing a character exploded from a base plate of the electroluminescent address plaque;

FIG. 10 is a rear perspective view of the electroluminescent address plaque shown in FIG. 9, showing the character exploded from the base plate;

FIG. 11 is rear elevational view of the character exploded from the electroluminescent address plaque shown in FIG. 9;

FIGS. 11A-11C are cross-sectional views of the address character taken at lines XIA-XIA, XIB-XIB, and XIC-XIC of FIG. 11;

FIG. 12 is an enlarged view of the address character attached at the base plate shown in the outlined area designated as section XII shown in FIG. 10, showing a fastener element of the address character engaged with an attachment aperture on the base plate;

FIG. 12A is a rear elevational view of the address character attached at the base plate shown in FIG. 12;

FIG. 13 is a cross-sectional view of the fastener element of the address character shown in FIG. 12 disengaged and spaced away from the attachment aperture on the base plate;

FIG. 13A is a cross-sectional view of the fastener element of the address character shown in FIG. 12 engaged with the attachment aperture on the base plate;

FIG. 14 is a front elevational view of different characters of an electroluminescent address plaque, showing whole number embodiments of the characters;

FIG. 15 is an upper perspective view of a portion of the electroluminescent address plaque, showing an electroluminescent wire exploded from a character of the electroluminescent address plaque;

FIG. 16 is an upper perspective view of the electroluminescent address plaque shown in FIG. 15, showing the electroluminescent wire attached to the character;

FIG. 17 is an elevational view of a wire mounting clip in a molded position;

FIG. 18 is a cross sectional view of the wire mounting clip shown in FIG. 17, taken at line XIX-XIX shown in FIG. 16, showing the clip in an installation position; and

FIG. 19 is a perspective cross sectional view of the wire mounting clip, taken at line XIX-XIX shown in FIG. 16, showing the clip in the installation position.

### DETAILED DESCRIPTION OF EMBODIMENTS

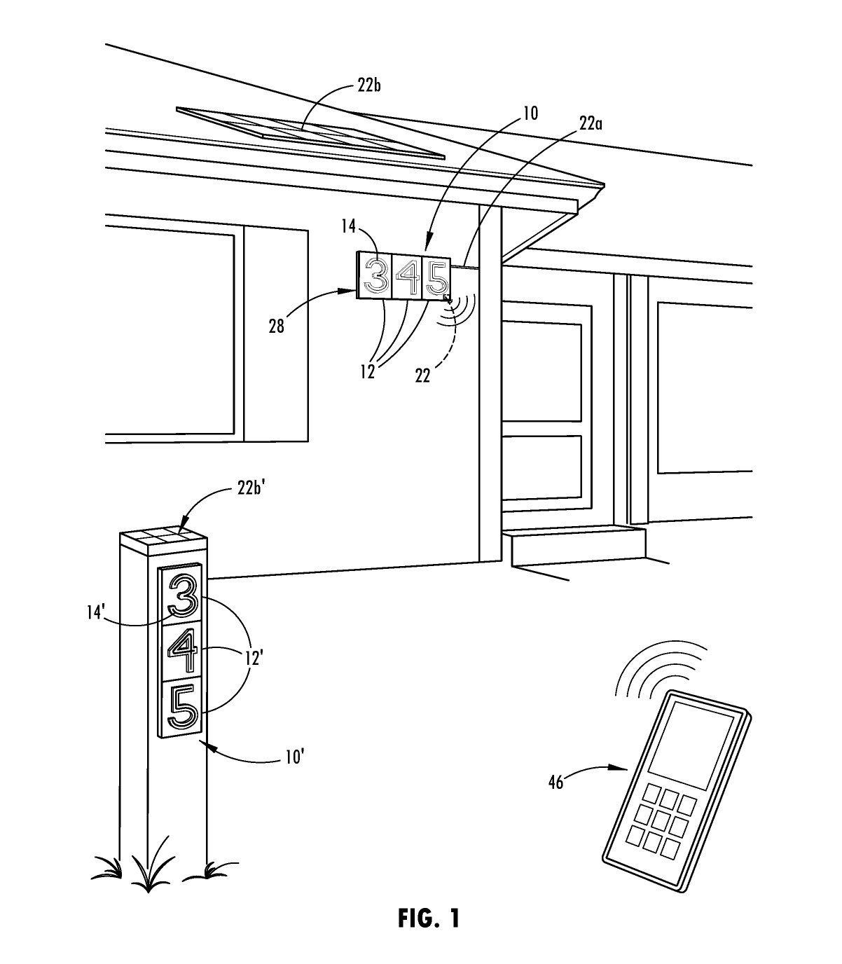

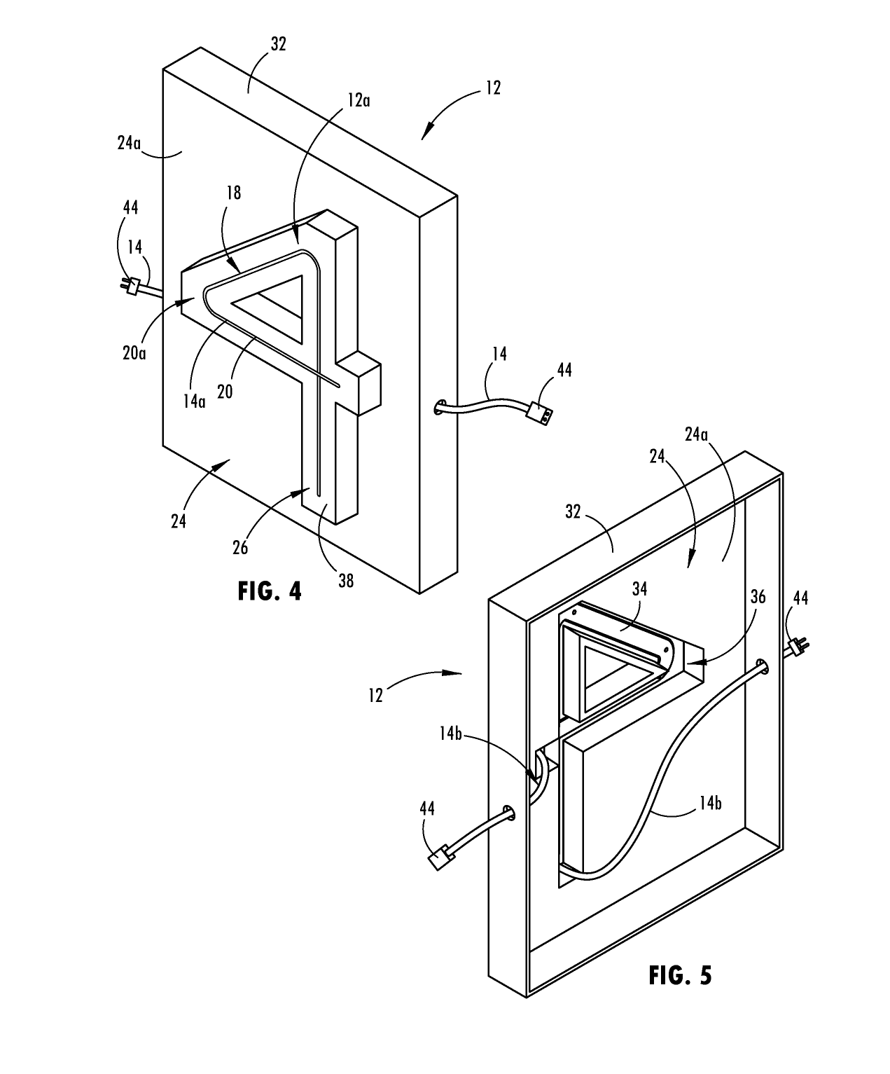

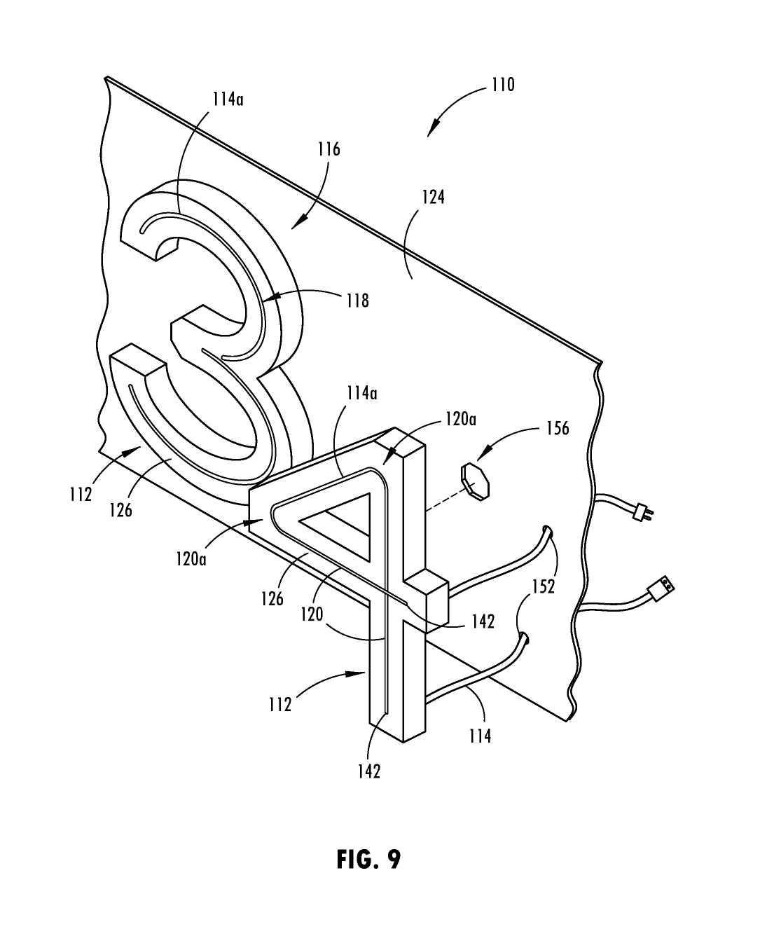

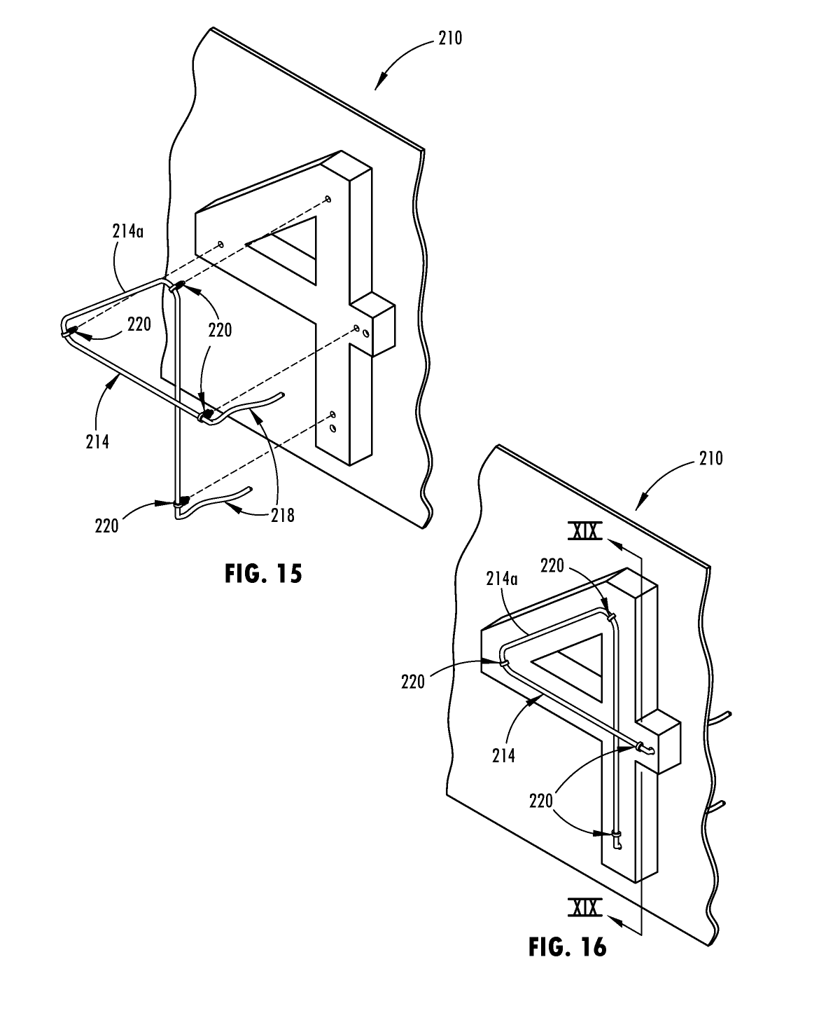

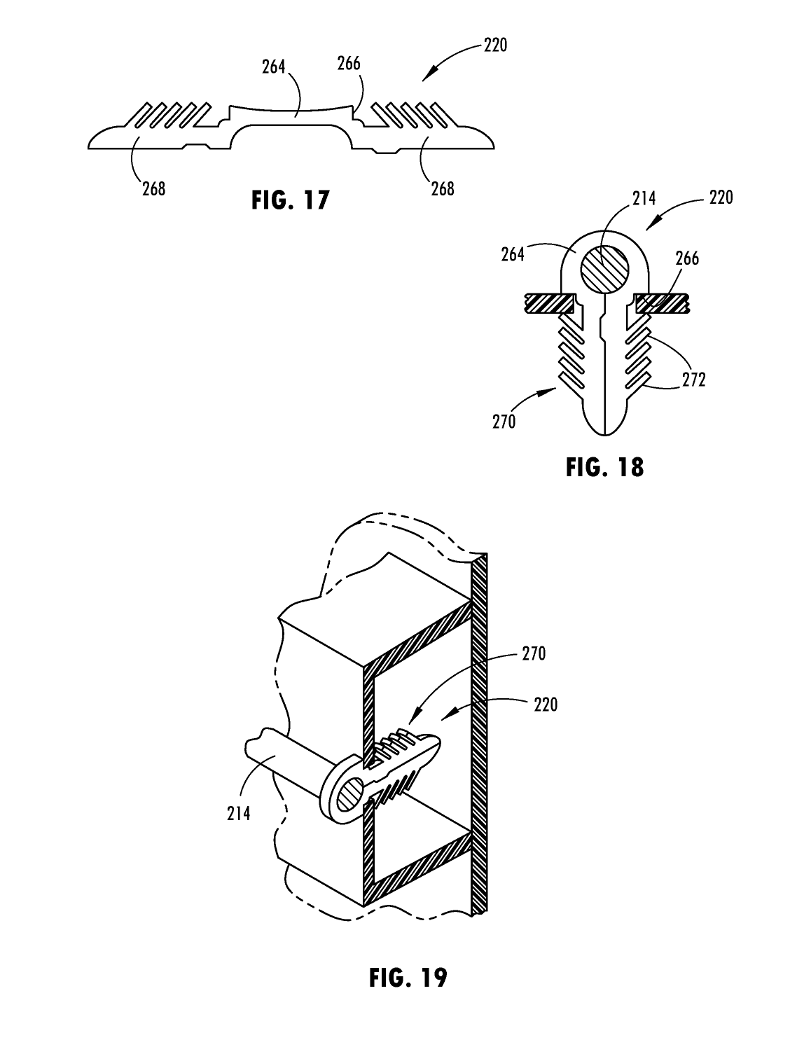

Referring now to the drawings and the illustrative embodiments depicted therein, an illuminating address plaque assembly 10 or kit includes characters elements 12 that are arranged or fixed relative to each other to display a desired address, such as shown in FIG. 1 with the plaque assembly 10 arranged horizontally on an exterior of a building and with the plaque assembly 10′ arranged vertically on a post. It is contemplated that the address plaque assembly 10 or kit may be attached or mounted at various address plaque mounting locations for indoor or outdoor display, such as near a front of a home, near a garage or access door, at or near a mail box, or other locations for displaying an address. An electroluminescent wire 14 or component is disposed over the character elements 12 in a shape or pattern that corresponds with the alphanumeric shape or display of the respective character portion 16 of the character element 12, thereby operating to illuminate the desired address. An intermediate section 14a of the electroluminescent wire 14 or component may be engaged with an attachment feature 18, such as a channel 20, 120 (FIGS. 4 and 9) and/or a retention clip 220 (FIGS. 15-19) or the like. Such an attachment feature 18 may be disposed on the character element 12 to support and hold the electroluminescent wire 14 or component in its alphanumeric shape at a front display portion 12a of the respective character element 12. The end sections 14b of the electroluminescent wire 14 or component may extend to a rear portion 12b of the character elements 12 to operably couple with a power source 22 (FIG. 1) for illuminating the electroluminescent wire 14 or component. Accordingly, the illuminating address plaque assembly 10 or kit allows a user to select and arrange character elements 12 in a desired configuration to display a desired address, such as in a string of two or more numbers or letters, and then attach the electroluminescent wire 14 or component over the front display portions of the characters elements 12 in a manner that will overlay the desired address, such that the character elements 12 themselves provides visibility of the address in daytime lighting conditions and the illuminated electroluminescent wire 14 or component itself provides a visible display of the address in the dark or nighttime.

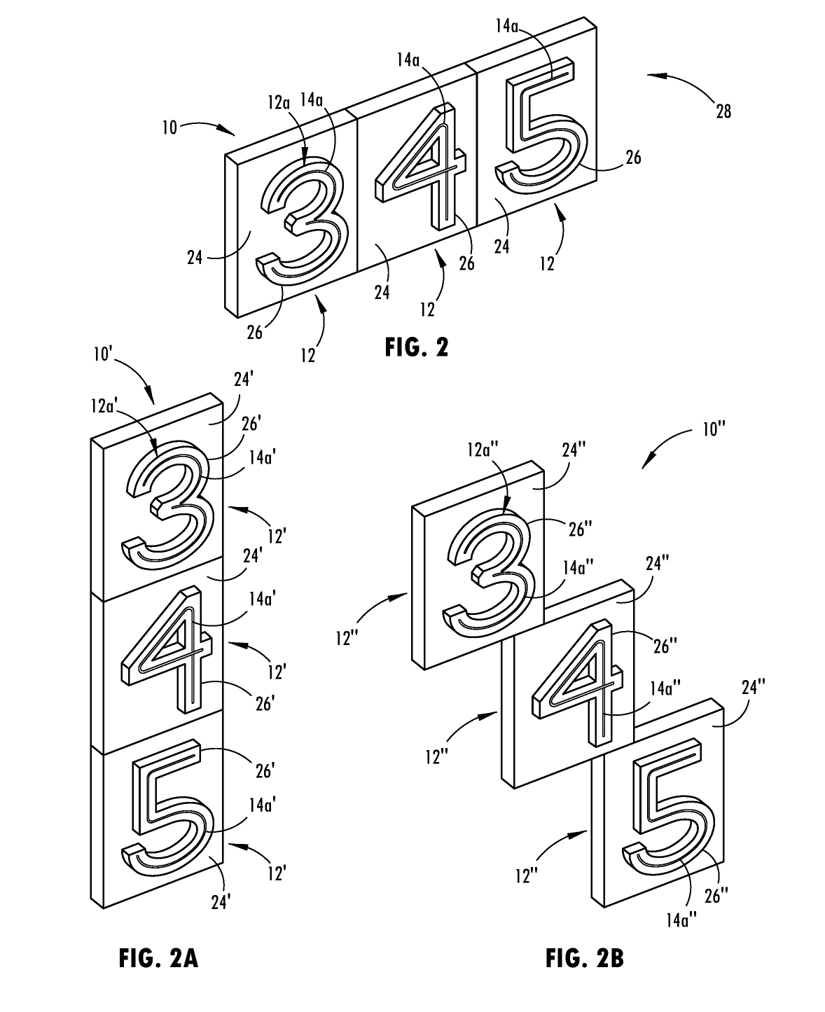

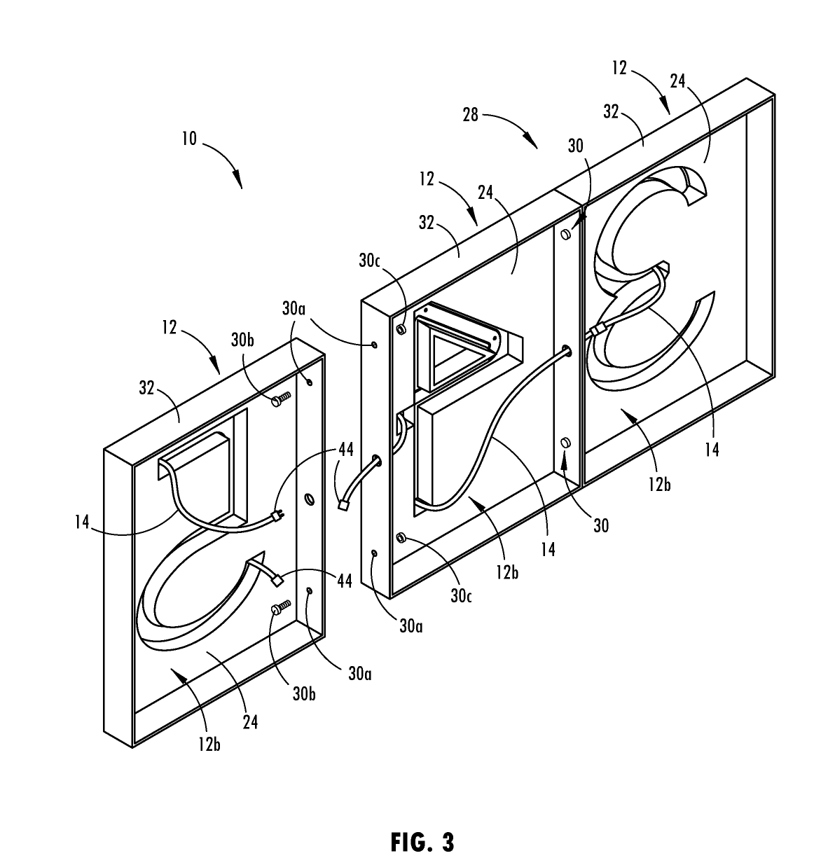

As shown in FIGS. 1-7, the characters elements 12 may include a frame portion 24 or structure that supports a character portion 26 or structure having a display of the alphanumeric character, such as shown with the character portion being character-shaped, having a physical shape of the alphanumeric character. The character portion 26 displays the alphanumeric character for visibility in lit conditions, such as during the daytime when the electroluminescent wire or component is not illuminated for visibility of the address. It is also contemplated that the character portion may optionally have an image or indicia of the alphanumeric character to display the alphanumeric character of the address in the alternative to or in addition to the character portion having a physical shape of the alphanumeric character. The frame portions 24 may be fixed relative to each other to arrange the character elements 12 in various configurations, such as in a generally horizontal arrangement (FIG. 2), a generally vertical arrangement (FIG. 2A), and a generally diagonal arrangement descending from left to right, (FIG. 2B), among other conceivable linear or non-linear arrangements. In these configurations, the frame portions 24 of the character elements 12 support the character portions 26 at a predetermined distances from an adjacent character element so that each number or letter the address is separate and distinguished from an adjacent number or letter.

As illustrated in FIG. 3, the frame portions 24 of the characters elements 12 may interconnect to form a single plaque unit 28 (FIG. 2) with the character portions 26 arranged to display in the desired address. A single character element 12 of the plaque unit 28 may thereby be attached or fastened to a supportive structure, such as a building or post as shown in FIG. 1, to support the entire plaque unit 28. To interconnect, the character elements 12 may each include connecting features 30 on opposing sides of a character portion 26 that are positioned to engage a corresponding connecting feature 30 of an adjacent character element 12. As shown in FIG. 3, the connecting feature 30 includes an aperture 30a that is formed through a side of a perimeter flange 32 of the frame portion 24. The aperture 30a aligns with an aperture 30a of an adjacent character element 12 to allow a fastener, such as a bolt 30b and nut 30c, to engage through both apertures 30a and secure the frame portions 24 together. The connecting features 30 may be arranged or formed at multiple sides of the character element to accommodate the desired arrangement or configuration of the address, such as at a top and/or bottom of the perimeter flange 32 to interconnect the character elements 12 in a vertical configuration (FIG. 2A) or stacked diagonal configuration (FIG. 2B).

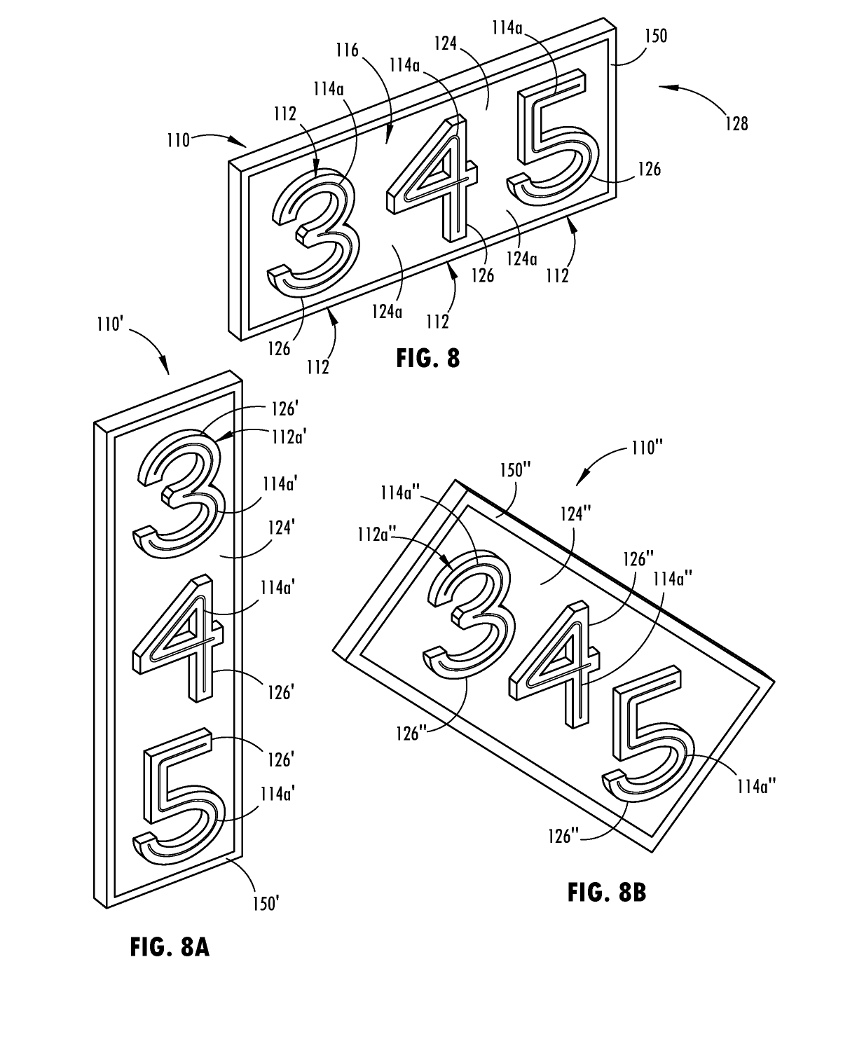

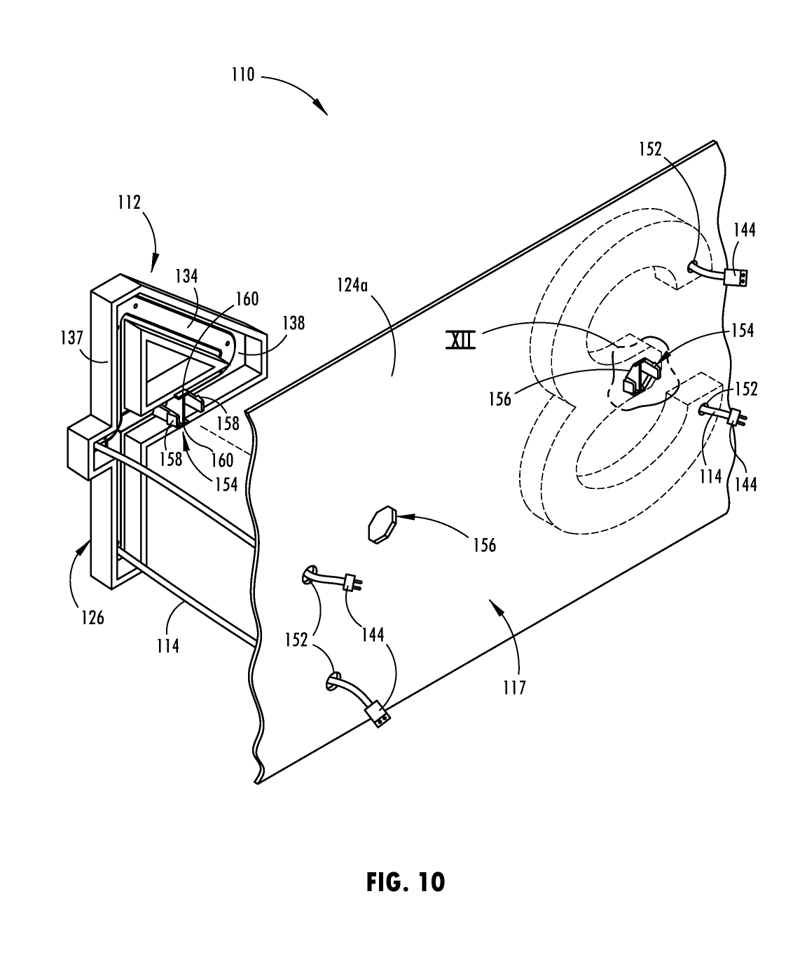

The frame portion 24 of each of the character elements 12 may be separate or an integral piece with the character portion 26 of the corresponding character element 12. If separate, the character portion 26 may be attached to the frame portion 24, such as with a fastener or clip or the like, such as described below with reference to FIGS. 9 and 10. As shown in FIGS. 3-6, the character portions 26 are integrally formed with the frame portion 24, whereby the character portion 26 is a physical shape of the alphanumeric character that protrudes forward from a planar section 24a of the frame portion 24, such as to define a block number shape or the like. To conceal and provide space for the electroluminescent wire and/or other components, the frame portion 26 may include the perimeter flange 32 that circumscribes the perimeter of the planar section 24a of the frame portion 24 and extends generally rearward. It is also contemplated that the planar section 24a may be similarly provided with a boarder or frame piece that attaches at a portion of each character to surround the assembled character elements of the desired address, such as shown in FIG. 8.

To provide illumination to each address character 12 of the address display, the electroluminescent wire 14 or component is disposed on the visible outer surface or display portion 12a of each address character 12. As shown in FIGS. 4-6, an intermediate section of the electroluminescent wire 14 is engaged with a channel 20 or groove that is disposed at the front display portion in a pattern corresponding with the alphanumeric shape of the respective character element. Accordingly, the only substantially visible portion of the electroluminescent wire 14 is the intermediate portion 14a engaged along the channel 20 of each address character 12. The illustrated channel 20 is formed generally continuously along a central portion of the alphanumeric shape with radiused curves 20a at the converging portions of the character that abruptly changes directions of the generally longitudinal portions of the character, thereby allowing the channel 20 to delineate the alphanumeric shape of the character with a single line. However, it is completed that the channel may alternatively outline an edge portion or other conceivable portion of the alphanumeric shape to similarly provide illumination to the character element in a manner that forms an alphanumeric shape with the same number or letter as the corresponding character portion.

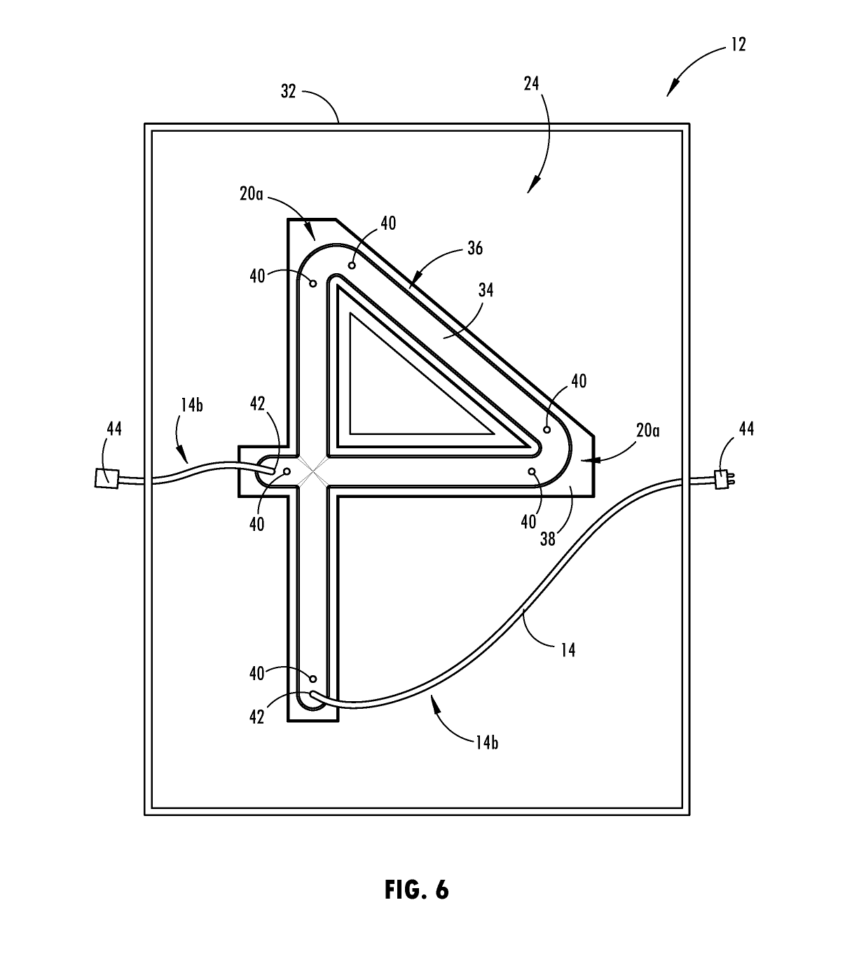

The channel 20 also forms a protrusion 34 on the rear surface along a hollow rear area 36 of the character portion 26, as the thickness of the front wall 38 may be substantially maintained proximate the channel 20, preventing weakening or stress risers that could otherwise be created if the front wall thickness was diminished by the channel 20. Accordingly, as shown in FIG. 6, it is also possible for small openings 40 to be formed through the front wall at select locations along the channel 20 to provide an access point inserting a tool for removing the electroluminescent wire 14 from its frictional retention in the channel 20. In additional embodiment, other means may additionally or alternatively be used to retain the electroluminescent wire 14 in the channel 20, such as retention clips and/or adhesive or the like.

The electroluminescent wire 14 is held by the channel 20 in the alphanumeric shape of the respective character 14 to provide a clear and highly visible shape of the respective character 14, whereby portions of the electroluminescent wire 14 not generally contained in the channel 20 are hidden behind the opaque frame portion of the character elements 12. More specifically, the end sections 14b of the electroluminescent wire 14 extend through the front display portion 12a or surface to a rear portion 12b of the respective character element 12 for operably coupling with a power source. As shown in FIG. 6, the end sections 14b of the electroluminescent wire 14 extend through holes 42 formed at end portions of the channel 20. The electroluminescent wire 14 is fed through a hole 42 at each end of the continuous channel 20, and extends to the rear portion 12b. As such, the holes 42 in the channel 20 provide an entry and exit point for the electroluminescent wire 14 that is fed through or snapped into the channel 20 or otherwise secured to the character element 12.

Once the electroluminescent wire 14 is fed through the channel 20 and out the holes 42 to the rear portion 12b of the character element 12, the electroluminescent wire 14 is then extended to an adjacent address character 12, and the same process repeats until each address character 12 is supplied with the electroluminescent wire 14. Accordingly, the character elements 12 may be preassembled with a section or piece of electroluminescent wire 14 having end connectors 44 (FIG. 3) to engage a section or piece of electroluminescent wire 14 in an adjacent character element or to connect to the power source. As such, the electroluminescent wire 14 may be pre-formed or over molded into the channel 14 of the address character. Optionally, a single piece of electroluminescent wire may laced through or disposed over more than one character element or all character elements in the address, such that replacing a deteriorated electroluminescent wire would only require a single replacement.

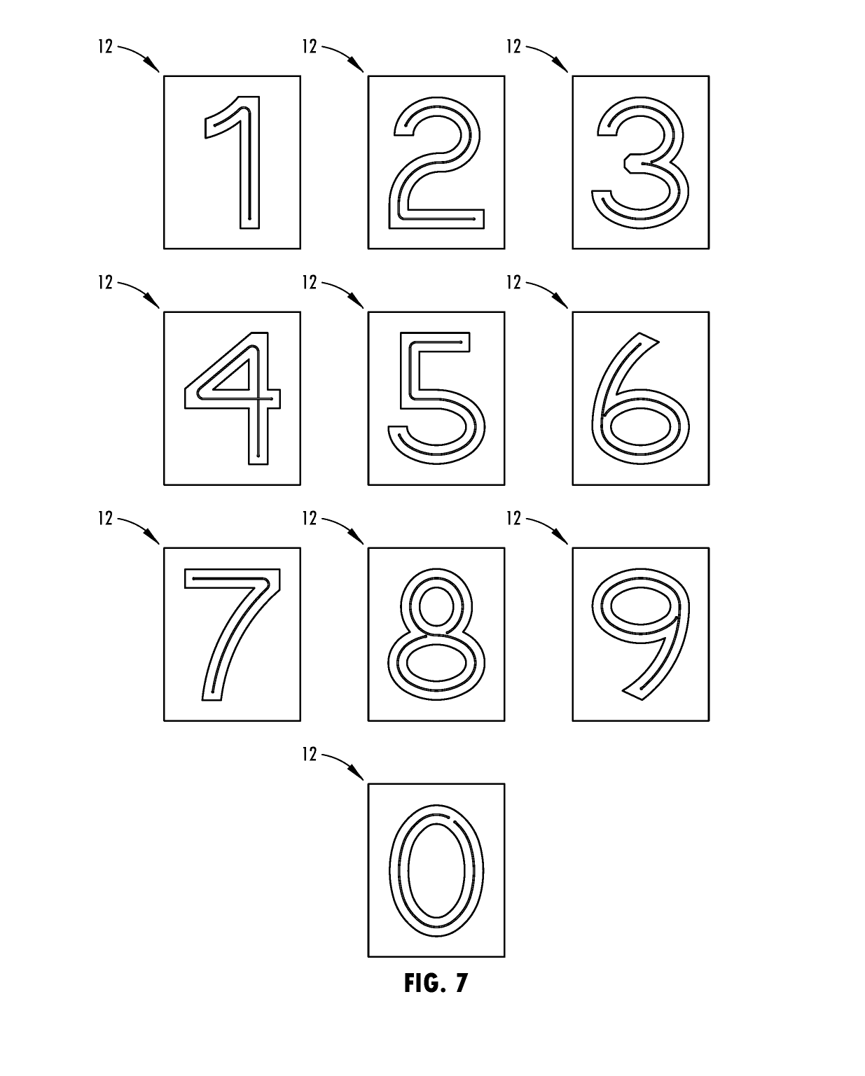

As shown in FIG. 7, various address character elements 12 are adapted so to have a common frame portion size and font design to similarly space the character portions from each other, such that any address combination of characters has the character portions and the illuminated characters generally equally spaced from each other. Also, the frame portions of each address character element are similarly shaped, as shown in a rectangle shape, to allow for the top and bottom edge surfaces to align in a horizontally configured address and the side edges to align in a vertically configured address. It is also contemplated that the frame portions and character portions of the character elements in additional embodiments may have different fonts, frame shapes, and spacing configurations from those shown in FIG. 7.

The end sections 14b of the electroluminescent wire 14 extend to a rear portion 12b of the plaque structure 28 to operably couple with a power source that selectively illuminates the desired address. Referring again to FIG. 1, the electroluminescent wire 14 is operably coupled with the power source 22, which in the illustrated embodiment is coupled with the rear surface of the plaque unit. The power source may include a power supply line 22a, which may provide an alternating current with a stepdown circuit, or a battery cell, such as a lithium ion cell or other conceivable types of batteries for providing direct current. Further, a solar element 22b, such as shown attached at roof or a post cap, may be electrically coupled with electroluminescent wire 14, such as via a battery cell to provide a naturally recharging power source. The power source 22 may also include an inverter for operating the electroluminescent wire 14 in a select one of a steady ON mode or solid illumination mode, a flashing illumination mode, and an OFF mode. The flashing illumination mode may be activated in a variety of frequencies to provide an alerting function, which may me incorporated with a home security system or other conceivable system that would benefit from such a flashing alert. The power source 22 may include a controller and/or a transceiver for selecting an operating mode with a wireless device 46, such as shown in FIG. 1, from a remote location in wireless communication with the electroluminescent wire 14. The wireless device 46 may also incorporate all or portions of the controller, and may include a smart phone, tablet, or other computing device or the like.

The character elements 12 in the illustrated embodiment of FIGS. 1-7 are preferably comprised of a weather resistant and opaque injection molded polymer, but it is conceivable that in additional embodiments the character elements may each include different materials, such as a different polymer, metal, fiber composite, ceramic, and any conceivable combination thereof. The electroluminescent wire 14 may include a variety of colors and in additional embodiments may be replaced with a light guide or an encased string of individual light sources, such as light emitting diodes (LEDs).

Referring now to the illuminating address plaque assembly 110 or kit shown in FIGS. 8-14, a unitary frame portion or base plate fixture 124 is provided for character portions 126 of the characters elements 112 to attach to a front surface 116 of the base plate fixture 124 and form a single plaque unit 128. The alphanumeric characters may each be designed to couple with the front surface 116 of the base plate fixture 124, such as in a snap-fit manner. The base plate fixture 124 may vary in length, depending on the number of address characters that are required to display the desired address. The base plate fixture 124 has a rear surface 117 opposite the front surface 116 that is designed to abut an address plaque mounting location, where the address plaque is attached for display, such as near a front of a home, near a garage or access door, at or near a mail box, or other locations for displaying an address. The unitary frame portion or base plate fixture 124 may be oriented in various configurations, such as in a generally horizontal arrangement (FIG. 8), a generally vertical arrangement (FIG. 8A), and a generally diagonal arrangement descending from left to right, (FIG. 8B), among other conceivable linear or non-linear arrangements. In these configurations, the base plate fixture 124 supports the character portions 126 at a predetermined distances from an adjacent character portion so that each number or letter the address is separate and distinguished from an adjacent number or letter.

To conceal and provide space for the electroluminescent wire and/or other components of the illuminating address plaque assembly 110 or kit, the base plate fixture 124 may include a boarder or frame piece 150 that attaches at an edge of a planar section 124a of the base plate fixture 124. As shown in FIG. 8, the frame piece thereby circumscribes the perimeter of the planar section 124a of the frame portion 124 and extends generally rearward to provide a recessed area between the rear side or portion 117 of the base plate fixture 124 and the address mounting location or surface.

To provide the illuminated address display, an intermediate section 114a of the electroluminescent wire 114 or component may be engaged with an attachment feature 118. Such an attachment feature 118 may be disposed on the character element 112 to support and hold the electroluminescent wire 114 or component in its alphanumeric shape at a front display portion of the respective character element 112. Each address character 112 may have a generally continuous channel 120 disposed over a visible outer surface of the respective character 112 in a pattern corresponding with the respective alphanumeric character. An electroluminescent wire 114 or component may be disposed over the character elements 112 in a shape or pattern that corresponds with the alphanumeric character, thereby operating to illuminate the desired address.

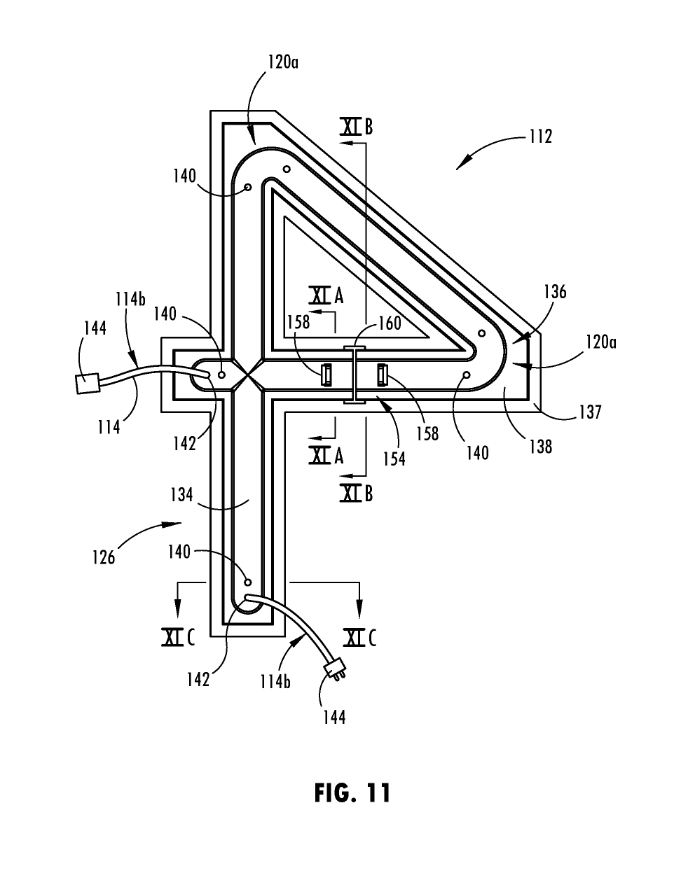

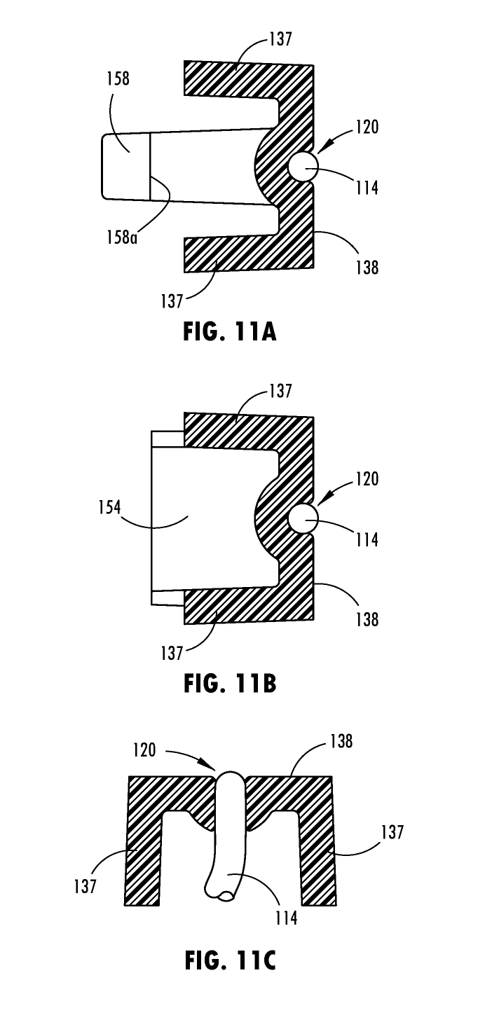

As shown in FIGS. 11A-11C, the electroluminescent wire 114 has an intermediate section 114a engaged along the continuous channel of each address character portion and end sections 114b of the electroluminescent wire 114 extending through holes 152 (FIG. 10) in the base plate fixture 124 for operably engaging a power source. As such, the only substantially visible portion of the electroluminescent wire 114 is the intermediate section 114a engaged along the channel 120 of each address character. Accordingly, the illuminating address plaque assembly 110 or kit allows a user to select and arrange character elements 112 in a desired configuration on the base plate fixture 124 to display a desired address, such as in a string of two or more numbers or letters, and then attach the electroluminescent wire 114 or component over the front display portions of the characters elements 112 in a manner that will overlay the desired address, such that the character elements 112 themselves provides visibility of the address in daytime lighting conditions and the illuminated electroluminescent wire 114 or component itself provides a visible display of the address in the dark or nighttime.

The illustrated channel 120 is formed generally continuously along a central portion of the alphanumeric shape with radiused curves 120a at the converging portions of the character that abruptly changes directions of the generally longitudinal portions of the character, thereby allowing the channel 120 to delineate the alphanumeric shape of the character with a single line. The electroluminescent wire 114 is fed through a hole 142 at each end of the continuous channel 120 and then through holes 152 in the base plate fixture 124 to extend extends to the rear portion. Once the electroluminescent wire 114 is fed through the holes 152 to the rear portion of the base plate fixture 124, the electroluminescent wire 114 may then extended to an adjacent address character 114, and the same process repeats until each address character element is supplied with the electroluminescent wire 114 and then ends of the wire 114 may be connected to the power source. As shown in FIGS. 8-16, a single piece of electroluminescent wire 114 may be used, such that replacing a deteriorated electroluminescent wire 114 would only require a single replacement. However, as shown in FIG. 5, the electroluminescent wire may be dedicated to a single address character, in which case the intermediate portion of the wire would only engage a groove of a single address character.

As shown in greater detail in FIGS. 11-11C, the rear side of an exemplary address character 126 has a hollow area 136 defined by the front and side walls 138, 137 of the block-shaped character. The side walls 137 extend generally perpendicularly rearward from the front wall 138 to give the character 126 the requisite depth for the channel 120 and to provide a block-character appearance. The illustrated front and side walls 138, 137 of the address character 126 are integrally formed as a single piece. The channel 120 on the front surface forms a protrusion 134 on the rear surface along the hollow area, as the thickness of the front wall 138 is substantially maintained proximate the channel 120, preventing weakening or stress risers that could otherwise be created if the front wall thickness was diminished by the channel 120. The cross section of the channel 120 is shown if in FIGS. 11A-11C encompassing more than half a circumference of the electroluminescent wire 114, such that the wire 114 is substantially retained in the channel 120, which provides a flush fit and appearance that clearly defines the alphanumeric shape of the address character. Small openings 140 may also be formed through the front wall at select locations along the protrusion to provide an access point inserting a tool for removing the electroluminescent wire 114 from its frictional retention in the channel 120. In additional embodiments, other means may additionally or alternatively be used to retain the electroluminescent wire 114 in the channel 120, such as retention clips or adhesive or the like.

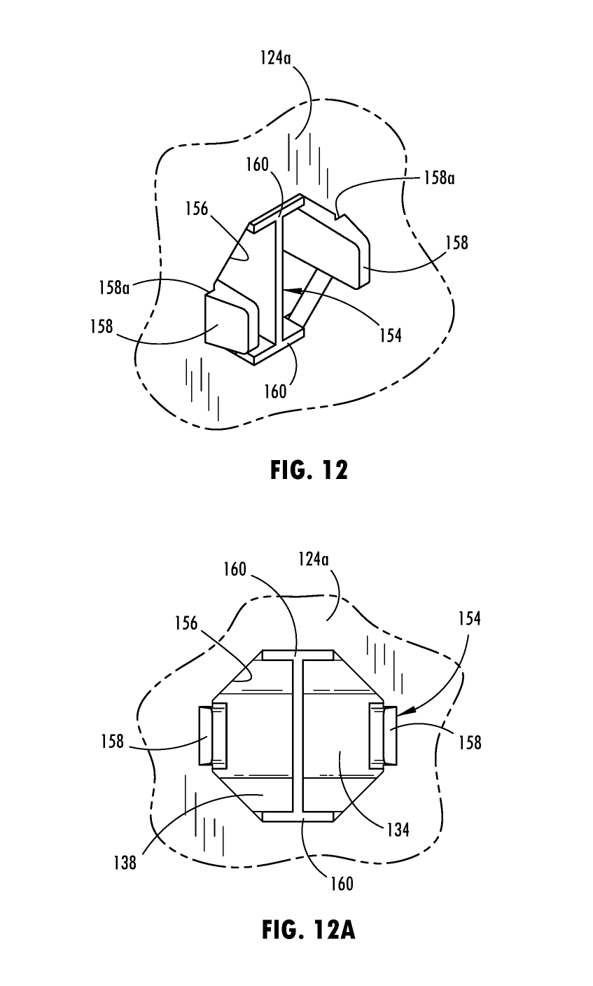

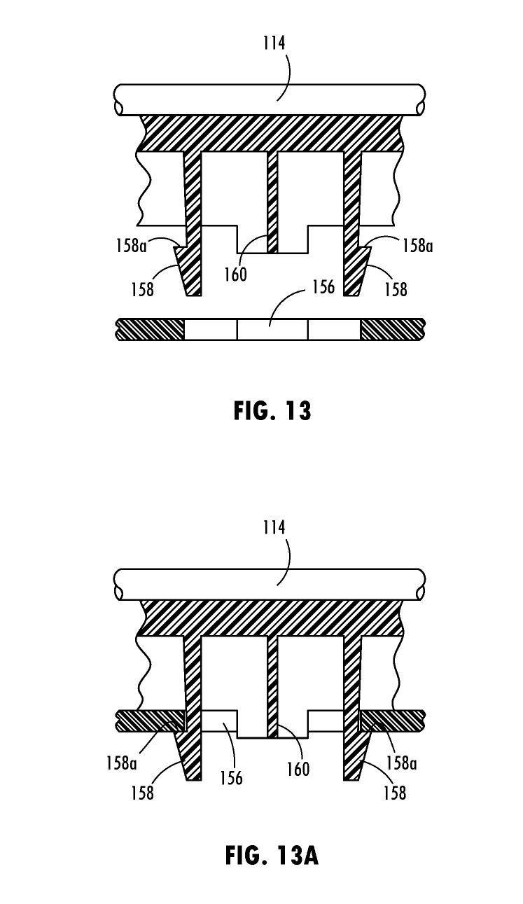

With reference to FIGS. 9 and 10, the inner surface of the address character 126 is shown with a single fastener 154 extending rearward therefrom to engage an attachment location 156 on the base plate fixture 124. The illustrated attachment location 156 is an octagon-shaped hole integrated into the base plate fixture 124. Accordingly, as shown in FIGS. 12 and 13, the fastener 154 in the illustrated embodiment has a four-sided connector that is designed to mate with the octagon-shaped hole in a select orientation, including a vertical, horizontal, and diagonal orientation. As shown in FIGS. 12 and 13, the illustrated fastener 154 has opposing resilient members 158 defining two of the sides and fixed flanges 160 defining the other two sides of the four-sided connector. The opposing resilient members 158 have a retention lip 158a (FIG. 13A) for snap-fitting into engagement with the octagon-shaped hole 156 (FIG. 12A). It is understood that the in additional embodiments, the fastener and attachment feature may be interchanged, provided with different mated fastening configurations, and/or provided with additional or alternative methods of fastening, such as threaded fasteners, adhesives, or rivets.

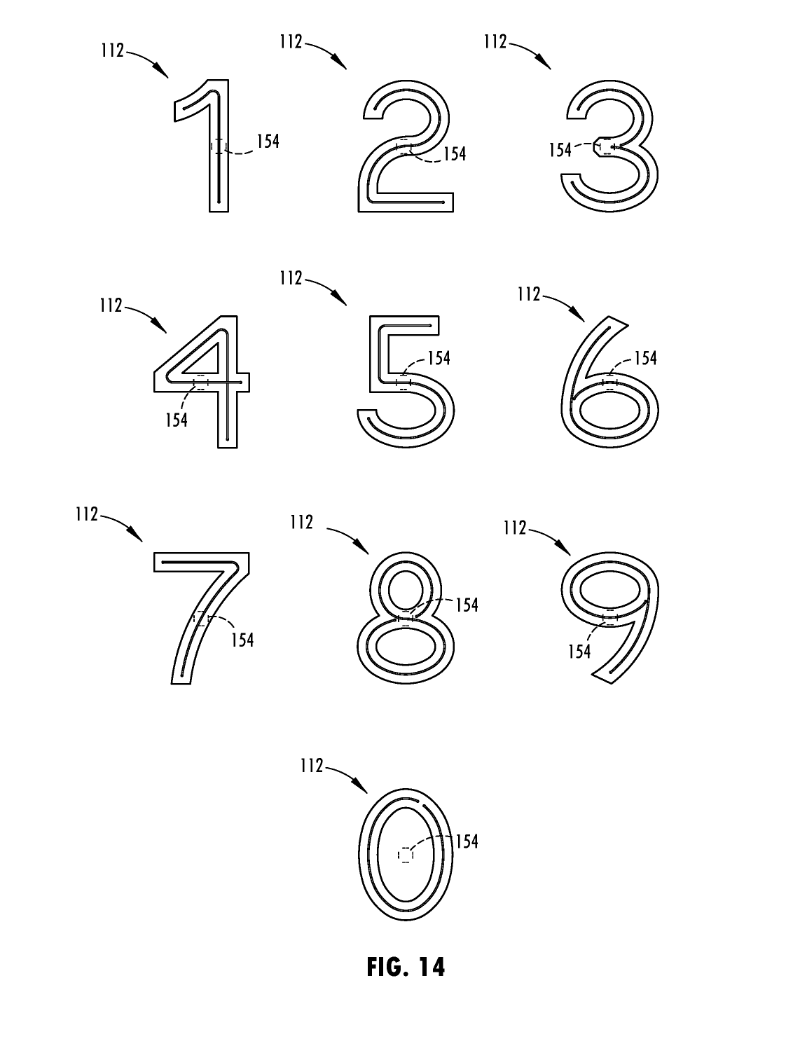

Referring generally to FIG. 14, each address character 112 may be designed so to have a common center point 160. The common center points 160 of each address character 126 may be provided with the fastener 154, allowing the base plate fixture 124 to be provided with the attachment location (i.e. octagon-shaped holes) in predefined spaced locations. These predefined attachment locations on the base plate fixture 124 and the described ability of multi-angle mating between the fasteners and the attachment features allows for each address character 126 to fit to the base plate fixture 124 in a uniform fashion, regardless of the angled orientation intended for mounting the base plate fixture 124, such as horizontal (FIG. 8), vertical (FIG. 8A), or diagonal (FIG. 8B) configurations.

It is contemplated that the base plate fixture 124 may include holes, such as pre-marked or perforated apertures, that are formed between the front and rear surfaces, such that the holes 142 in the address characters may align with some of the holes 152 for the electroluminescent wire 114 to extend from the channel 120 to the rear portion of the base plate fixture 124. The holes 152, such as the pre-marked or perforated apertures, may be punched out or drilled out upon assembly. The perforated apertures may also be arranged on the base plate fixture 124 in a pattern that allows each of the various potential numbers or letters, including those shown in FIG. 14, to be secured to the base plate fixture 124 at any of the predefined character locations with the holes 142 of the characters aligned with the holes 152 in the base plate fixture 124 for attaching the electroluminescent wire 114 Accordingly, it is contemplated that the perforated or preformed apertures may be segmented in clusters that form the predefined placement locations for the address characters.

The character 126 and the base plate fixture 124 in the illustrated embodiment of FIGS. 8-15 are preferably comprised of a weather resistant and opaque injection molded polymer, but it is conceivable that in additional embodiments the character 126 and the base plate fixture 124 may each include different materials, such as a different polymer, metal, fiber composite, ceramic, and any conceivable combination thereof. The electroluminescent wire 114 may include a variety of colors and in additional embodiments may be replaced with a light guide or an encased string of individual light sources, such as light emitting diodes (LEDs).

Referring now to FIGS. 15-19, the illuminating address plaque assembly 210 or kit includes an attachment feature 218 for engaging an intermediate section 214a of the electroluminescent wire 214 to support the electroluminescent wire 214 at the characters elements 212. The illustrated retention clip 220 is shown for surrounding the electroluminescent wire 214 and retaining it to a select location on character element 212. The retention clip 220 includes a wire engagement portion 264 with an abutment surface 266 and a pair of legs 268 that are engaged upon folding the clip 262 into the installation position, thereby forming a shank 270 with a series of retention flanges 272 that prevent the clip 220 from being removed from an insertion aperture. Alternatively, the retention clip 220 may be used for retaining an additional electroluminescent wire on or around a border of the plaque unit, if desired. Such additional electroluminescent wire could also be powered by a separate inverter, which allows the additional electroluminescent wire to be operated (i.e. in a solid illumination or flashing illumination) separate from the illuminated characters of the address display. The additional electroluminescent wire may also be of different color from illuminated address display.

Accordingly, the illuminating address plaque assembly 10, 110, 210 or kit includes characters elements that are arranged or fixed relative to each other to display a desired address at various address plaque mounting locations for indoor or outdoor display. An electroluminescent wire 14, 114, 214 or component is disposed over the character elements in a shape or pattern that corresponds with the alphanumeric shape or display of the respective character portion of the character element, thereby operating to illuminate the desired address. The illuminating address plaque assembly or kit allows a user to select and arrange character elements in a desired configuration to display a desired address, such as in a string of two or more numbers or letters, and then attach the electroluminescent wire or component over the front display portions of the characters elements in a manner that will overlay the desired address, such that the character elements themselves provides visibility of the address in daytime lighting conditions and the illuminated electroluminescent wire or component itself provides a visible display of the address in the dark or nighttime.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

For purposes of this disclosure, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations, except where expressly specified to the contrary. It is also to be understood that the specific devices and processes illustrated in the attached drawings, and described in this specification are simply exemplary embodiments of the inventive concepts defined in the appended claims. Hence, specific dimensions and other physical characteristics relating to the embodiments disclosed herein are not to be considered as limiting, unless the claims expressly state otherwise.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature; may be achieved with the two components (electrical or mechanical) and any additional intermediate members being integrally formed as a single unitary body with one another or with the two components; and may be permanent in nature or may be removable or releasable in nature, unless otherwise stated.

Changes and modifications in the specifically-described embodiments may be carried out without departing from the principles of the present invention, which is intended to be limited only by the scope of the appended claims as interpreted according to the principles of patent law including the doctrine of equivalents.

What is claimed is:

1. An illuminating address plaque assembly, comprising:
a plurality of character elements arranged to display a desired address;
wherein a front display portion of each of the plurality of character elements includes an attachment feature;
an electroluminescent wire having an intermediate section engaged with the attachment feature and disposed at or near the front display portion in a pattern corresponding with an alphanumeric shape of the respective character element; and
wherein end sections of the electroluminescent wire extend through the front display portion to a rear portion of the respective character element for operably coupling with a power source.

2. The illuminating address plaque assembly of claim 1, wherein the attachment feature on the front display portion of each of the plurality of character elements includes a channel having the pattern corresponding with the alphanumeric shape of the respective character element.

3. The illuminating address plaque assembly of claim 2, wherein the channel on the front display portion of each of the plurality of character elements includes a hole at end portions of the channel, such that the end sections of the electroluminescent wire extend through the holes.

4. The illuminating address plaque assembly of claim 1, wherein the plurality of character elements each include a frame structure and a character-shaped structure that has the attachment feature for engaging the electroluminescent wire, and wherein the frame structure supports the character-shaped structure at a predetermined distance from an adjacent character element.

5. The illuminating address plaque assembly of claim 4, wherein frame structure of each the plurality of character elements attaches to a frame structure of an adjacent character element to space the character-shaped structures from each other in the arrangement of the desired address.

6. The illuminating address plaque assembly of claim 4, wherein the frame structure of each of the plurality of character elements is an integral piece of the character-shaped structure of the corresponding character element of the plurality of the character elements.

7. The illuminating address plaque assembly of claim 1, wherein the plurality of character elements each include connecting features on opposing sides of a character-shaped portion of each of the plurality of character elements, the connecting features arranged to engage a corresponding connecting feature of an adjacent character element to arrange character-shaped portions to form a plaque unit that has the desired address.

8. The illuminating address plaque assembly of claim 1, further comprising:
a base panel for securing the plurality of character elements in a linear arrangement that displays the desired address.

9. The illuminating address plaque assembly of claim 8, wherein the base panel includes a series of attachment locations spaced substantially equally over a length of the base panel, the attachment locations each configured to engage one of the plurality of character elements in a desired angular orientation that includes one of a horizontal orientation, a vertical orientation, and a diagonal ordination.

10. The illuminating address plaque assembly of claim 1, wherein the electroluminescent wire is configured to operate in a select one of a solid illumination mode and a flashing illumination mode.

11. An illuminating address plaque assembly, comprising:
a plurality of character elements, each having a frame portion supporting a character portion that displays an alphanumeric character;
wherein the frame portions of the plurality of character elements are interconnected to form a plaque unit with the character portions arranged in a desired address;
an electroluminescent component having an intermediate section coupled with the character portion of at least one of the plurality of character elements and disposed in a shape corresponding with the alphanumeric character of the respective character portion; and
wherein end sections of the electroluminescent component extend to a rear portion of the plaque structure to operably couple with a power source that selectively illuminates the desired address.

12. The illuminating address plaque assembly of claim 11, further comprising a wire attachment feature disposed at a front surface of the character portion of the at least one of the plurality of character elements, wherein the electroluminescent component comprises an electroluminescent wire, and wherein the attachment feature removably engages the intermediate section of the electroluminescent wire.

13. The illuminating address plaque assembly of claim 12, wherein the wire attachment feature includes a channel that frictionally engages the electroluminescent wire and extends over the front surface in a shape that aligns with a corresponding section of the alphanumeric character.

14. The illuminating address plaque assembly of claim 11, wherein the frame portion of each the plurality of character elements attaches to a frame portion of an adjacent character element to space the character portions from each other in the arrangement of the desired address.

15. The illuminating address plaque assembly of claim 11, wherein the frame portion of each of the plurality of character elements is an integral piece with the character portion of the corresponding character element of the plurality of the character elements.

16. The illuminating address plaque assembly of claim 11, wherein the frame portions of the plurality of character elements each include a first connecting feature at a first edge portion and a second connecting feature at a second edge portion spaced from the first edge portion, and wherein the first connecting features of contiguous character elements are configured to interconnect for displaying the desired address in a vertical orientation, and wherein the second connecting features of continuous character elements are configured to interconnect for displaying the desired address in a horizontal orientation.

17. A method of assembling an illuminating address plaque, comprising:
selecting a plurality of character elements that each have an alphanumeric character;
arranging the selected plurality of character elements in a fixed configuration to display a desired address with the corresponding alphanumeric characters;
attaching an electroluminescent wire at a front display portion of the character elements in a pattern corresponding with at least a portion of the alphanumeric character of the respective character element; and
inserting the electroluminescent wire through the front display portion of the character elements to extend to a rear portion of the respective character element.

18. The method of claim 17, further comprising:
engaging an intermediate portion of the electroluminescent wire along a channel, wherein end portions of the electroluminescent wire extend to the rear portion of the base panel for operably engaging a power source.

19. The method of claim 17, further comprising:
selecting an operating mode for the electroluminescent wire from one of a steady mode and a flashing mode, wherein the operating mode is selected with a device in wireless communication with a receiver operably coupled with the electroluminescent wire.

20. The method of claim 19, further comprising:
providing a base panel having a front surface and an opposing rear surface;
securing the plurality of character elements to the front surface of the base panel;
operably coupling end portions of the electroluminescent wire with a power source; and
electrically connecting a solar element with the power source.
